(19) United States
(12) Patent Application Publication
(10) Pub. No.: US 2025/0190908 A1
(43) Pub. Date: Jun. 12, 2025

(54) TRUCK ALLOCATION SYSTEM

(71) Applicant: TECK RESOURCES LIMITED, Vancouver (CA)

(72) Inventors: Aliakbar Soleymani KOOHBANANI, North Vancouver (CA); Mohammad TABESH, Coquitlam (CA); Scott GREENE, North Vancouver (CA); Carlos VIEJO, Vancouver (CA)

(73) Assignee: TECK RESOURCES LIMITED, Vancouver, BR (CA)

(21) Appl. No.: 18/838,930

(22) PCT Filed: Feb. 16, 2023
(86) PCT No.: PCT/CA2023/050205

§ 371 Date: Aug. 15, 2024

Related U.S. Application Data
(60) Provisional application No. 63/311,294, filed on Feb. 17, 2022.

(51) Int. Cl. G06Q 10/0631; G06Q 10/04; G06Q 50/02

(52) U.S. Cl. CPC G06Q 10/06316; G06Q 10/04; G06Q 50/02

(57) ABSTRACT

Mine sites are known to include a variety of vehicles of various different types and ages. Such a variety increase the difficulty of the dispatcher's job of allocating the vehicles in a manner that optimizes production of material. In particular, different vehicles and different operators may be shown to handle route conditions, such as grade and curvature, at different speeds. A truck allocation system is able to provide suggestions for vehicle allocation based on the vehicles operating parameters and route geometry. Ideally, implementation of the suggestions for vehicle allocation act to increase production.

### CROSS-REFERENCE TO RELATED APPLICATIONS

This application is the U.S. national stage of International Patent Application No. PCT/CA2023/050205 filed Feb. 16, 2023, which claims the benefit of and priority to U.S. Provisional Patent Application No. 63/311,294, titled TRUCK ALLOCATION SYSTEM, filed Feb. 17, 2022, both of which are incorporated by reference herein in their entireties.

### TECHNICAL FIELD

The present disclosure relates to a truck allocation system in a mine operation and, in particular, to components of a truck allocation system that provides recommendations relating to allocation of various vehicles to various routes in the mine operation.

### BACKGROUND

An open pit mining operation may include a plurality of shovels for digging up the raw material, a plurality of loaders for loading the raw material onto trucks and a plurality of trucks. Notably, loaders and shovels may be shown to perform many of the same tasks, but with different rate and flexibility. That is, shovels may load raw material onto trucks and loaders may dig up raw material. The trucks may be adapted for transporting material to predetermined destinations. For one example, the trucks may be adapted for transporting spoils to a spoils pile. For another example, the trucks may be adapted for transporting raw material to a breaker for initial processing of the raw material.

A dispatcher may be considered to be a quarterback of a mine site, in that the dispatcher is often responsible for making decisions that may be shown to impact multiple key performance indicators (KPIs) throughout day-to-day operations. Typically, the dispatcher is trying to monitor several different computer screens and several different 3rd party applications, while communicating using multiple phones and radios.

A pit supervisor is often given the task of managing the operation on the ground. For large mining sites, there may be several pit supervisors managing different sections of the mining site. Each pit supervisor may share, with the dispatcher, some responsibility for decisions that may be shown to impact the KPIs. Notably, however, each pit supervisor may also be accountable for addressing safety issues and personnel issues in their respective section of the pit. Each pit supervisor may drive a vehicle around the mine site and is often responsible for equipment that is geographically separate from equipment for which other pit supervisors are responsible. Typically, each pit supervisor has access to a mobile phone and, sometimes, has access to a laptop in the vehicle. Notably, each pit supervisor should pay attention to their surroundings at all times.

Many mine sites include various different types and ages of vehicles, which adds difficulty to the dispatcher's job of allocating the various vehicles, e.g., trucks, in a manner that optimizes production. In particular, different vehicles and/or different operators may be shown to handle route conditions, e.g., grade and curvature, differently. Moreover, some vehicles, e.g., trucks, handle certain route conditions, e.g., grade, incrementally differently, while other vehicles handle other route conditions, e.g., curvature, substantially differently.

### SUMMARY

Aspects of the present application relate to optimizing production at a mine site by obtaining recommendations for vehicle allocation based on various vehicle operating parameters and based on route geometry. The recommendations may be obtained from an optimization system configured to execute an optimization algorithm. Inputs to the optimization system include objectives, constraints and estimates for a time expected to be taken for each vehicle among a plurality of vehicles to travel each route among a plurality of routes. The estimates may be obtained from a machine learning implementation trained on historical data from the mine site.

According to an aspect of the present application, there is provided a method of determining vehicle travel time for a route at a mine site. The method includes collecting, from a plurality of vehicles, recorded historical vehicle operation data, the historical vehicle operation data specifying a route, among a plurality of routes at the mine site, on which the historical vehicle operation data has been recorded and training, using the historical vehicle operation data, a machine learning system to estimate a travel time for a particular vehicle on a particular route, thereby generating a trained machine learning system. The historical vehicle operation data includes, vehicle features for the particular vehicle, route features for the particular route and weather condition data. The method further includes determining, using the trained machine learning system, an estimated travel time for a vehicle among the plurality of vehicles on a route among the plurality of routes at the mine site.

According to an aspect of the present application, there is provided a system for determining vehicle travel time for a route at a mine site. The system includes a non-transitory memory storing computer instructions and a controller processor. The controller processor is caused, by executing the instructions, to collect, from a plurality of vehicles, recorded historical vehicle operation data, the historical vehicle operation data specifying a route, among a plurality of routes at the mine site, on which the historical vehicle operation data has been recorded. The controller processor is further caused, by executing the instructions, to train, using the historical vehicle operation data, a machine learning system to estimate a travel time for a particular vehicle on a particular route, thereby generating a trained machine learning system. The historical vehicle operation data includes vehicle features for the particular vehicle, route features for the particular route and weather condition data. The controller processor is further caused, by executing the instructions, to determine, using the trained machine learning system, an estimated travel time for a vehicle among the plurality of vehicles on a route among the plurality of routes at the mine site.

According to an aspect of the present application, there is provided a method producing vehicle allocation recommendations. The method includes obtaining a plurality of estimated cycle times for a plurality of vehicles on a plurality of routes at a mine site, each cycle time obtained by summing a first estimated travel time for a particular vehicle, among the plurality of vehicles at a mine site, traveling on a first route, among the plurality of routes, in a first direction and a second estimated travel time for the particular vehicle traveling on a second route, among the plurality of routes, in a second direction. The method further includes obtaining a plurality of constraints, the plurality of constraints including a penalty for fleet mixing, obtaining a plurality of objectives, the plurality of objectives including a shovel target, providing, to an optimizer system executing an optimizer algorithm, the plurality of estimated cycle times, the plurality of constraints and the plurality of objectives. The method further includes receiving, from the optimizer system subsequent to execution of the optimizer algorithm, an optimizer output including a plurality of vehicle allocation recommendations.

According to an aspect of the present application, there is provided a system for determining vehicle travel time for a route at a mine site. The system includes a non-transitory memory storing computer instructions and a controller processor. The controller processor is caused, by executing the instructions, to obtain a plurality of estimated cycle times for a plurality of vehicles on a plurality of routes at a mine site, each cycle time obtained by summing a first estimated travel time for a particular vehicle, among the plurality of vehicles at a mine site, traveling on a first route, among the plurality of routes, in a first direction and a second estimated travel time for the particular vehicle traveling on a second route, among the plurality of routes, in a second direction. The controller processor is further caused, by executing the instructions, to obtain a plurality of constraints, the plurality of constraints including a penalty for fleet mixing, and obtain a plurality of objectives, the plurality of objectives including a shovel target. The controller processor is further caused, by executing the instructions, to provide, to an optimizer system executing an optimizer algorithm, the plurality of estimated cycle times, the plurality of constraints and the plurality of objectives. The controller processor is further caused, by executing the instructions, to receive, from the optimizer system subsequent to execution of the optimizer algorithm, an optimizer output including a plurality of vehicle allocation recommendations.

### BRIEF DESCRIPTION OF THE DRAWINGS

Some example embodiments will be described in greater detail with reference to the accompanying drawings, wherein:

FIG. 1 illustrates, in a schematic diagram, a mining operation;

FIG. 2 illustrates, in a schematic diagram, a truck cycle in a mining operation;

FIG. 3 illustrates, in a schematic diagram, an example truck allocation system including a machine learning model and a, in accordance with aspects of the present application;

FIG. 4 illustrates a map, of a mine site, that may be generated by the example truck allocation system of FIG. 3, in accordance with aspects of the present application;

FIG. 5 illustrates example steps in a method that may be carried out at the truck allocation system of FIG. 3, in accordance with aspects of the present application;

FIG. 6 illustrates an example vehicle page, including references to a plurality of vehicle cards, as part of an example graphic user interface for the truck allocation system of FIG. 3, in accordance with aspects of the present application;

FIG. 7 illustrates an example vehicle card referenced by the example vehicle page of FIG. 6, in accordance with aspects of the present application;

FIG. 8A illustrates a first example Trucks to Reallocate table, in accordance with aspects of the present application;

FIG. 8B illustrates a second example Trucks to Reallocate table, in accordance with aspects of the present application;

FIG. 8C illustrates an example Reallocated Trucks table, in accordance with aspects of the present application;

FIG. 8D illustrates an example Trucks to Keep in Current Location table, in accordance with aspects of the present application;

FIG. 9 illustrates an example optimized recommendation list of vehicle-to-route allocations, in accordance with aspects of the present application;

FIG. 10 illustrates, schematically, the machine learning model of FIG. 3, to emphasize inputs and outputs, in accordance with aspects of the present application; and

FIG. 11 illustrates, schematically, the optimizer system of FIG. 3, in accordance with aspects of the present application.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art.

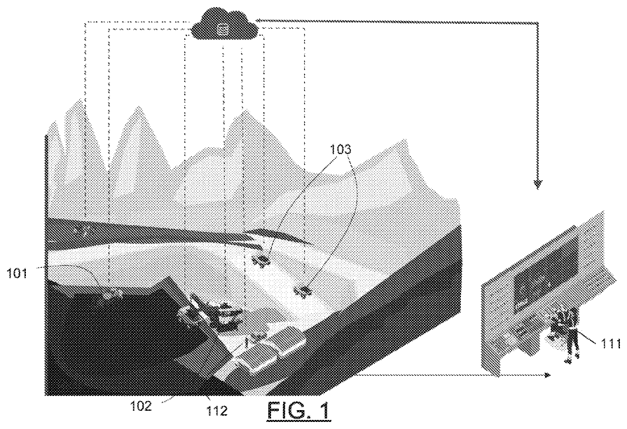

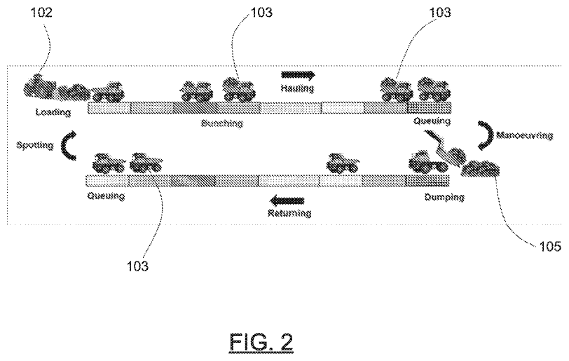

With reference to FIGS. 1 and 2, an open pit mining operation utilizes a plurality of vehicles including a plurality of trucks 103. The plurality of vehicles may also include a plurality of loading units, e.g., shovels 101 for digging up raw material and loaders 102 for loading the raw material onto the trucks 103. It may be shown that the plurality of trucks 103 transport the raw material over various routes to one or more dumping sites 105. A set of examples of the dumping sites 105 may include a breaker for initial processing of the raw material. The set of examples of the dumping sites 105 may also include a spoil pile.

FIG. 1 includes a representation of a dispatcher 111. The dispatcher 111 may be considered to be a quarterback of a mine site, in that the dispatcher 111 is often responsible for making decisions that may be shown to impact multiple key performance indicators (KPIs) throughout day-to-day operations. Typically, the dispatcher 111 attempts to monitor several different computer screens and several different 3^{rd} party applications, while communicating using multiple phones and radios.

FIG. 1 includes a representation of a pit supervisor 112. The pit supervisor 112 is often given the task of managing the operation on the ground. For large mining sites, there may be several pit supervisors 112 managing different sections of the mining site. Each pit supervisor 112 may share, with the dispatcher 111, some responsibility for decisions that may be shown to impact the KPIs. Notably, however, each pit supervisor 112 may also be accountable for addressing safety issues and personnel issues in their respective section of the pit. Each pit supervisor 112 may drive a vehicle around the mine site and is often responsible for equipment that is geographically separate from equipment for which other pit supervisors are responsible. Typically, each pit supervisor 112 has access to a mobile phone and, sometimes, has access to a laptop in the vehicle. Notably, each pit supervisor should pay attention to their surroundings at all times.

FIG. 1 includes a representation of a shovel 101. With reference to FIG. 2, a typical cycle in a typical mining operation includes the shovel 101 piling raw material in a loading site. Notably, the shovels 101 may be associated with drills (not shown). It is a responsibility of the loaders 102, at the loading site at which the raw material has been piled by the shovel 101, to load the raw material onto the plurality of trucks 103. Alternatively, and more usually, the shovels 101 may directly load the trucks 103, that is there may be no need for the loader 102 between the shovel 101 and the truck 103. Once loaded, the trucks 103 may be expected to travel a route from the shovel 101 (or the loader 102) at the loading site to one of the dumping sites 105, e.g., a breaker or a spoils pile. The trucks 103 may take time getting into position for loading. Subsequent to being loaded, the trucks 103 may bunch up during hauling and queueing on the way to dump their respective loads at respective dumping sites 105. The trucks 103 may also take time getting into position for dumping. After dumping their respective loads, the trucks 103 may be shown to proceed to make a return trip, via the route to the loading site. The return trip may result in bunching and queuing delays, thereby completing the cycle. It can readily be seen how these steps may cause a loss of production.

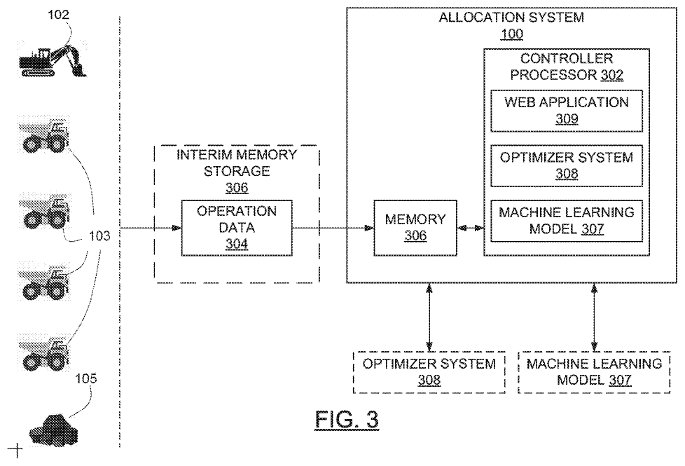

With reference to FIG. 3, a truck allocation system 100 comprises a controller processor 302. The controller processor 302 may carry out aspects of the present application by executing computer instructions. The computer instructions may be stored on a non-transitory, computer-readable storage medium 303, which may also be referenced herein as memory 303. The memory 303 may, for example, be implemented as a local storage medium or a cloud-based storage medium. The truck allocation system 100 may be configured to receive operation data 304. The operation data 304 may be understood to have been transmitted from various vehicles and/or locations, e.g., the shovels 101, the loaders 102, the trucks 103 and the dumping sites 105. The operation data 304 may be transmitted, via a suitable communication network, for storage on the non-transitory computer-readable storage medium 303 or for storage on an optional interim non-transitory memory storage 306. The operation data 304 may include vehicle operation data, such as global positioning system (GPS) location data, speed data, tire temperature data, fuel consumption data, load weight data, strut pressure data. The operation data 304 may also include data regarding production of material, e.g., bank cubic meters (BCM), processed from one or more breakers or from the trucks 103. The operation data 304 may also include data regarding features of current mine conditions, e.g., road quality and recent weather data. The controller processor 302 of the truck allocation system 100 may implement a machine learning model 307 by executing an artificial intelligence (AI) machine learning (ML) algorithm, e.g., XGBoost. The term “XGBoost” is short for extreme Gradient Boosting, which is an open-source software library that provides a regularizing gradient boosting framework for C++, Java, Python, R, Julia, Perl and Scala. Documentation for XGBoost is hereby incorporated herein by reference. The machine learning model 307 may be used for estimating the travel time on each potential route for each truck 103. The controller processor 302 of the truck allocation system 100 may further implement an optimizer system 308, by executing an optimizer algorithm, to determine truck allocation recommendations to increase total BCM/hour for the mine site. The optimizer system 308 may execute the optimizer algorithm to determine truck allocation recommendations to meet other additional or alternative objectives. For example, one objective may involve minimizing overall cost. Another example objective may involve minimizing a fuel burn rate. A further example objective may involve increasing total material moved. As illustrated in FIG. 3, the machine learning model 307 and the optimizer system 308 may be implemented at the controller processor 302. Alternatively, the machine learning model 307 and/or the optimizer system 308 may be implemented external to the controller processor 302. When implemented externally, the implementation may be carried out in the same internal network as the truck allocation system 100 or may be carried out in another network. in the latter case, the machine learning model 307 and/or the optimizer system 308 may provide output via a suitable communication network. The optimizer system 308 may comprise a known Mixed-Integer Linear Programming (MILP) solver or some other suitable optimizer system. The known Gurobi™ Optimizer software, from Gurobi Optimization LLC of Beaverton, Oregon, has been found to be suitable for use as the optimizer system 308.

As illustrated in FIG. 3, the controller processor 302 of the truck allocation system 100 may implement a truck allocation web application 9. The truck allocation web application 9 may be shown to enable remote access, to the truck allocation system 100, through the use of a graphic user interface (GUI), by external users, e.g., the dispatcher 111 and the pit supervisors 112, via a suitable network, e.g., the known Internet and successor networks.

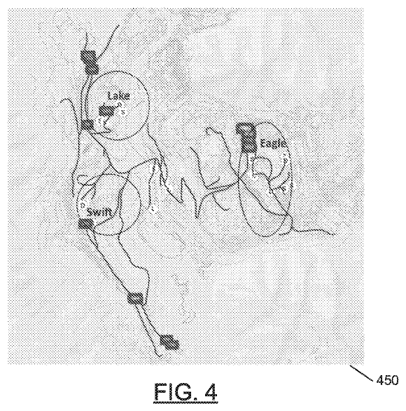

With reference to FIG. 4, a map 450 of the mine site may be generated by the truck allocation system 100, on the basis of output from known mapping tools, e.g., Google Maps™. The map 450 may be generated on the basis of input from a user and/or the operation data 304. As discussed hereinbefore, the operation data 304 may, for example, include a GPS position for the shovels 101, the loaders 102, the trucks 103 and the dumping sites 105. The map 450 may be a dynamic map. Accordingly, the map 450 may include constantly updated locations. On the map 450, illustrated in FIG. 4, locations marked with a letter “D” may be understood to represent the dumping sites 105. On the map 450, illustrated in FIG. 4, locations marked with a letter “S” may be understood to represent the shovels 101. On the map 450, illustrated in FIG. 4, locations marked with a letter “L” may be understood to represent the loaders 102. On the map 450, illustrated in FIG. 4, locations identified by a number in a box may be understood to represent locations of trucks 103.

Routes used by the trucks 103 are also indicated, on the map 450, illustrated in FIG. 4, with dark lines. Different pits, labeled as “Lake,” “Eagle” and “Swift,” are generally identified on the map 450, illustrated in FIG. 4, with a geometric figure, e.g., oval or circle.

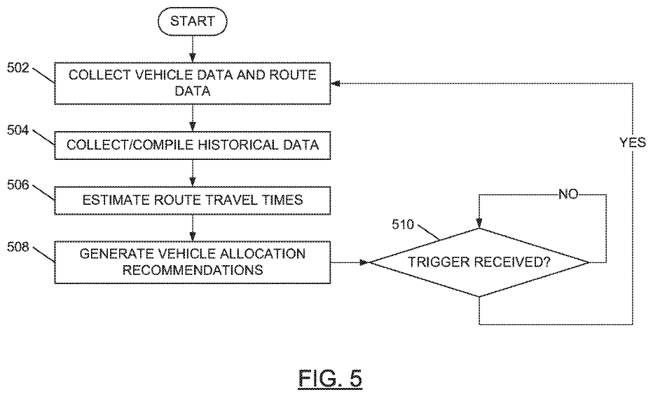

FIG. 5 illustrates example steps in an allocation method that may be carried out at the truck allocation system 100 of FIG. 3. The truck allocation system 100 may initially collect (step 502) vehicle data and route data. More particularly, the truck allocation system 100 may collect (step 502) a list of available vehicles, e.g., the shovels 101, the loaders 102 and the trucks 103. The list of available vehicles may include vehicles details, such as make, model, horsepower and year. The truck allocation system 100 may also collect (step 502) a list of routes at the mine site. For example, the routes in the list may include all of the routes displayed on the map 450. Each route on the list of routes may be associated with indications of characteristics of the route.

Each route may be divided into sections based on characteristics, such as: grade; and curvature. The grade characteristic may be expressed as, e.g., uphill, extreme uphill, downhill or extreme downhill. The curvature characteristic may be expressed as, e.g., straight, sharp turn or shallow turn. A given section of a route may be associated with a length indication representative of the portion of the route associated with the indicated characteristic.

At this stage, a number of trucks 103 may have already been allocated to specific routes, based on the characteristics of the routes, the shovels 101, the loaders 102 and the trucks 103, to maximize material moved, while trying to achieve individual targets associated with each shovel 101. Typically, a constraint on the number of trucks 103 per route is called a Box Factor, which may be represented as a percent of total theoretical capacity per shovel 101 that is targeted as part of a site mining strategy. The Box Factor may be shown to allow for some flexibility within the cycle (see FIG. 2), if there is bunching or other issues that may cause delays. A typical Box Factor may be shown to be in a range between 90%-95%, inclusive.

The truck allocation system 100 may next collect and compile (step 504) historical operation data, such as GPS location data, speed data, tire temperature data, fuel consumption data, load weight data, strut pressure data, weather data and production of material data, e.g., BCM. The truck allocation system 100 may collect and compile (step 504) historical operation data for each vehicle, e.g., each shovel 101, each loader 102 and each truck 103. The truck allocation system 100 may collect and compile (step 504) historical operation data for each route over a predetermined period of time, e.g., 365 days. It should be understood that more data, or data gathered over a longer time period, is expected to lead to more accurate estimates. The truck allocation system 100 may collect and compile (step 504) the historical operation data from the data collected and stored in the non-transitory computer-readable storage medium 303 or stored in the interim non-transitory memory storage 306.

The truck allocation system 100 may determine, from the historical operation data, load times and spot times for one or more of the shovels 101, the loaders 102 and the dumping sites 105. Each of the load times and the spot times may be an average value based on the last predetermined number of days, e.g., adjusted to a percentage of the 365 day average based on the last 2-5 shift average actuals. The dispatcher 111 may be allowed to manually adjust the load and spot times, based on knowledge that something has significantly changed in the digging conditions from the last 2-5 shifts.

The historical operation data collected and compiled in step 504 may include a cycle time for each truck 103 during the last period of time over each route travelled. Notably, a cycle includes a route from the loader 102 to the dumping site 105 and a route from the dumping site 105 to the loader 102. While, at first glance, the two routes may appear to be the same, it may be considered that the two routes in the cycle are different. Indeed, if the route from the dumping site 105 to the loader 102 includes a section with an extreme downhill grade, it follows that the route from the loader 102 to the dumping site 105 will include a section with an extreme uphill grade.

Historical data may be filtered before being used as input to the machine learning model 307. For example, historical data for a given truck 103 traveling with a speed within a predetermined range, e.g., from 10 km/h to 60 km/h, may be used, while historical data for a given truck 103 traveling with a speed outside the same predetermined range, e.g., from 10 km/h to 60 km/h, may be eliminated. Similarly, routes with data recorded over the course of more than a minimum number of cycles, e.g., 10 cycles, may be used, while routes with less than the minimum number of cycles, e.g., 10 cycles, may be filtered out.

The truck allocation system 100 may allocate a given truck 103 to a combination of a given shovel 101 and a corresponding dumping site 105 in a manner that acts to increase productivity, e.g., to optimize a quantity of material moved. To do this, the truck allocation system 100, may use the operation data 304 from the loaders 101, the shovels 101 and the dumping sites 105. For example, the operation data 304 may include: how much the shovels 101 dig material; how fast each loader 102 loads a truck 103; and how much material the mine site is trying to move on a per shovel 101 basis. The truck allocation system 100 may also use how much material each dumping site 105 is targeted to receive per shift. Limitations may be included, as well, if, for example, a given shovel 101 only has a certain amount of material available to move and will run out of available material during a shift. In this case, fewer trucks may be allocated by the truck allocation system 100, so that a target quantity of material is moved, while allowing extra trucks 103 to be used, more efficiently, elsewhere. Accordingly, an objective may be expressed as a shovel target for the given shovel 101. A shovel target, for a given shovel 101, may be expressed in terms of an amount of material and a time period, say, a shift.

The truck allocation system 100 may next use the machine learning model 307 to estimate (step 506) a route travel time for each potential route in the entire mine site for each truck 103 (and operator) based on the historical operation data, even though each truck 103 may not have ever travelled each route. The truck allocation system 100 may next use the machine learning model 307 to characterize each route that each truck 103 has travelled. The characterization may be accomplished in terms of, e.g., length, grade and curvature of each route. The truck allocation system 100 may next use the machine learning model 307 to separate each route into sections by characterization. The truck allocation system 100 may use the machine learning model 307 to evaluate how each truck 103 has performed on each different type of section. For example, the truck allocation system 100 may use the machine learning model 307 to aggregate each route from a plurality of route segments, e.g., 50 m to 500 m, based on route features or complexity, such as one or more of: flat (−2%<grade<2%); uphill (2%<grade<7%); extreme uphill (7%<grade<10%); downhill (−7%<grade<−2%); extreme downhill (−10%<grade<−7%); straight; curved; extremely curved. Notably, it may be that a mine site configuration does not allow for a road to have a grade greater than 10%. The truck allocation system 100 may use the machine learning model 307 to define a length for each route segment until the route feature changes. Alternatively, the truck allocation system 100 may use the machine learning model 307 to separate each route into equal route segments, e.g., 50 m in length, and associate, with each route segment, a feature based on the most significant of the features of the route segment. Then, the truck allocation system 100 may use the machine learning model 307 to generate a segment travel time for each route segment, e.g., each 50 m route segment, of the route based on corresponding segment features. The truck allocation system 100 may then use the machine learning model 307 to aggregate the route segment times to obtain total route travel time. Subsequently, a total route travel time in one direction may be summed with a total route travel time in an opposite direction to arrive at a total cycle travel time.

The truck allocation system 100 may then use the machine learning model 307 to estimate route travel times for each truck 103 on all of the routes at the mine site, not just the routes that each truck 103 has already travelled. The output from the machine learning model 307 may be a route travel time for each truck 103 (and operator) on each route. The inputs to the machine learning model 307 may include, for a given truck 103, one or more of the following: meters traveled in different grade categories; meters traveled in different curve categories; road complexity; a truck fleet indication; and horsepower of the given truck 103. The grade categories may include, e.g., extreme uphill, uphill, flat, downhill and extreme downhill. The curve categories may include, e.g., sharp curve, gentle curve and straight. The road complexity may be a metric representative of a combination of route features. The truck fleet indication may include, e.g., make, model and year of the given truck 103.

The truck allocation system 100 may use the machine learning model 307 to obtain an estimated average speed of each truck 103 and/or operator within 5% of the actual average speed over a variety of different types of routes including various features, e.g., uphill, downhill, shallow curve and sharp curve. For example, for a given truck 103 travelling at an actual average speed 30 km/h, the truck allocation system 100 may use the machine learning model 307 to obtain an estimated average speed that is within 5% of the actual average speed. That is, the estimated average speed is likely to be in a range extending from 28.3 km/h to 31.7 km/h.

The optimizer system 308, executing an optimizer algorithm, may generate (step 508) a vehicle allocation recommendation based on the route travel times (estimated in step 506) for each of the plurality of trucks 103 on each of the plurality of routes. In particular, the optimizer algorithm may be configured to optimize production, e.g., BCM. A fleet mixing cost, e.g., a metric representative of a cost (in time or currency) of moving a given truck 103 to a given route, may be determined based on the average route travel time difference of the grade categories and curve categories on every route. The truck allocation system 100 may be configured to, whenever possible, avoid reallocating a truck 103 from a first route to a second route, e.g., between pits or as a part of mixing fleets, when the second route is more than a set distance from the first route. It follows that a penalty, e.g., expressed in time or BCM, may be associated with each allocation recommendation that requires a truck 103 to change between routes that are more than a set distance apart or that require mixing fleets. The truck allocation system 100 may be configured with a preference for only mixing trucks 103 with a relatively small difference in their route travel times. An example “small” difference is 5-20 minutes.

The entire process can be updated automatically at a given time period, e.g., each shift or day or week, or manually, as desired. The truck allocation system 100 may determine (step 510) whether a trigger has been received. The trigger may be understood to cause the method represented by steps 502, 504, 506 and 508 to be repeated to, thereby, update the recommendations generated in step 508 on the basis of more up-to-date data collected in step 502.

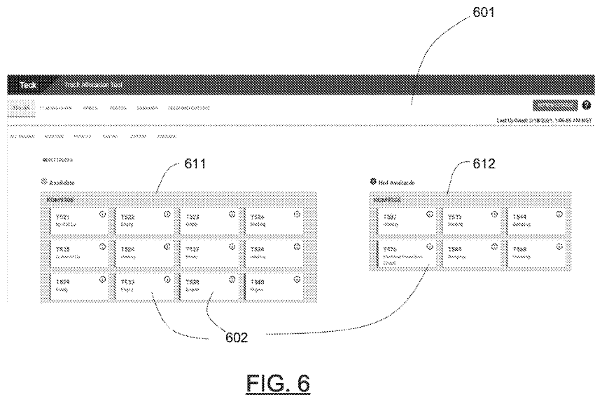

With reference to FIG. 6, as a consequence of collecting (step 502) the list of available vehicles and the list of routes in the mine site, the truck allocation system 100 may control a user interface to include a vehicle allocation page 601. As illustrated in FIG. 6, the vehicle allocation page 601 may illustrate the status of the vehicles, e.g., the trucks 103, the shovels 101, the loaders 102, etc. In aspects of the present application, the status of the vehicles may be displayed, on the vehicle allocation page 601, all at once. In other aspects of the present application, the status of the vehicles may be displayed, on individual vehicle allocation pages 601, one vehicle allocation page 601 for each type (e.g., truck 103, shovel 101 or loader 102) of vehicle. That is, there may be a vehicle allocation page 601 specific to trucks 103. The vehicle allocation page 601 for each type of vehicle may be accessed by tabs in a header. The truck allocation system 100 may obtain vehicle status inputs, for example, by analyzing the operation data 304. The truck allocation system 100 may, additionally or alternatively, obtain vehicle status inputs from the operators of the vehicles 101, 102, 103. The truck allocation system 100 may, additionally or alternatively, obtain vehicle status inputs from the dispatcher 111. Upon obtaining the vehicle status inputs, the truck allocation system 100 and/or the dispatcher 111 may determine those vehicles that are available for the next truck allocation recommendation.

The vehicle allocation page 601 may include a plurality of vehicle cards 602. Each vehicle card 602 may include one or more of the following: operational status data; and current status description data.

The operational status data may include one status or a plurality of status, e.g., available, needs attention and not available. The operational status data may be indicated by displaying the vehicle card 602 using a particular background color, where the particular background color is associated with the operational status data. The operational status data “available” may be indicated by using a green background color for the vehicle card 602. The operational status data “available” may be understood, by, say the dispatcher 111, as an indication that the corresponding vehicle has no issues and is available for work. The operational status data “needs attention” may be indicated by using a yellow background color for the vehicle card 602. The operational status data “needs attention” may be understood, by, say the dispatcher 111, as an indication that the corresponding vehicle is not down, but has reasons for not being available. The operational status data “not available” may be indicated by using a red background color for the vehicle card 602. The operational status data “not available” may be understood, by, say the dispatcher 111, as an indication that the corresponding vehicle is currently down with issues. The dispatcher 111 may need to get additional information.

The dispatcher 111 may use the current status description data to obtain a sense of whether the vehicle, e.g., a truck 103, is expected to be available soon or is expected to not be available for an extended period of time. For one example, when the current status description data indicates “Scheduled-PM,” the dispatcher 111 may understand that the vehicle is receiving preventative maintenance and, accordingly, is unlikely to be available for the next shift. For another example, when the current status description data indicates “Unscheduled Mechanical-No Start,” the dispatcher 111 may understand that the vehicle is experiencing a starting issue. The dispatcher 111 may further understand that starting issue are known to be fixed quickly the field maintenance teams.

As illustrated in FIG. 6, the truck allocation system 100 may configure the vehicle allocation page 601 to include an “Available” container 611 and a “Not Available” container 612. An update to the data displayed in each of the vehicle cards 602 may be automatically triggered (see step 510, FIG. 5) every five minutes. An update to the data displayed in each of the vehicle cards 602 may be manually triggered (see step 510, FIG. 5) responsive to the dispatcher 111 activating a user interface element, such as a Reset Trucks tab or Reset Trucks button. Responsive to the operational status data being updated, either automatically triggered or manually triggered, the truck allocation system 100 may sort the vehicle cards 602 into the containers 611, 612 according to respective operational status data. As a consequence of the sorting, the Available container 611 may include vehicle cards 602 with green backgrounds and vehicle cards 602 with yellow backgrounds and the Not Available container 612 may include vehicle cards 602 with red backgrounds.

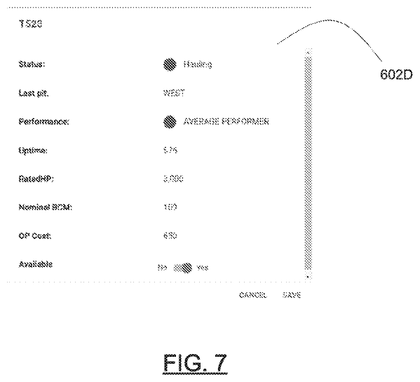

Responsive to a user, such as the dispatcher 111, interacting with (e.g., clicking on) a particular vehicle card 602 for a particular vehicle, e.g., a particular truck 103, the truck allocation system 100 may control the truck allocation web application 309 to open a detailed vehicle card 602D (see FIG. 7) to display one or more of: status data; last pit data; performance data; uptime data; rated HP data; nominal BCM data; OP cost data; and availability data.

The status data may be understood to be a short description representative of the operational status of the vehicle. The status data may be color-coded and may correspond to the color and status of the corresponding vehicle card 602. The short status description may be shown to help the dispatcher 111 to identify the current condition.

The last pit data may be understood to be an indication of the last pit at the terminus of the route to which the particular vehicle was assigned. The last pit data may be understood to help to provide a high-level context for a current location of the particular vehicle.

The performance data may be understood to be representative of a value that the machine learning model 307 has applied to the particular vehicle based on historical performance when compared to similar vehicles, e.g., similar trucks 103. The performance data may be implemented as a label with a corresponding color. The label may be selected from: above average; average; and below average.

The uptime data may be understood to be a metric representative of an amount of time during which the particular vehicle is expected be operating in a shift, e.g., excluding breaks like lunch breaks and coffee breaks. The uptime data metric may be used to predict the expected number of cycles that the particular vehicle can contribute to producing BCM.

The rated HP data may be understood to be representative of an actual power of an engine in the particular vehicle. On rare occasions, the maintenance team may lower or raise the horsepower of a vehicle for different reasons. For example, horsepower may be reduced to reduce wear on engine parts.

For those cases in which the particular vehicle is a truck 103, the nominal BCM data may be understood to be representative of a size of a truck box for the truck 103. The size of the truck box may be understood to be representative of a volume available for hauling material.

The OP cost data may be understood to be representative of an operating cost to run the particular vehicle. The operating cost may be a sum of costs involved in allowing the particular vehicle to operate. The sum may include fuel costs, driver wages and wear on tires and parts. The truck allocation system 100 may use the machine learning model 307 to convert the sum from dollars to BCM. On the detailed vehicle card 602D of FIG. 7, the OP cost data has a value of 650, which may be understood to be expressed in BCM/Hr. On a settings page, an administrator may adjust this OP cost data for every vehicle.

The availability data may be understood to be representative of an availability of the particular vehicle for the next recommendation. The detailed vehicle card 602D may be manually updated responsive to a user, such as the dispatcher 111, toggling an available tab from on to off or from off to on.

Each truck 103 is inherently a member of a single group of trucks. It should be clear that different mine configurations may involve organizing trucks into groups differently. The truck allocation system 100 may recognize that each vehicle card 602 is associated with a truck 103 that belongs to a defined group of trucks. One group to which a given truck 103, associated with a vehicle card 602, may belong may be understood to include those trucks that have, in common, a make. Another group to which the given truck 103 may belong may be understood to have, in common, a model. Another group to which the given truck 103 may belong may be understood to have, in common, an age. Another group to which the given truck may belong may be understood to have, in common, a horsepower. Another group to which the given truck 103 may belong may be understood to have, in common, an average route travel time.

The dispatcher 111 may configure the user interface to view all vehicle cards 602 in a particular fleet or to simply view all vehicles. So-called “fleet mixing” occurs when vehicles with different fleet assignments, e.g., route travel times, are assigned on the same route.

Since a fleet may be defined to include vehicles having an average route travel time in common, it may be considered to be fleet mixing when a pair of vehicles with different average route travel times are assigned to the same route to a particular loader 102. The truck allocation system 100 may be configured to avoid fleet mixing to increase a likelihood that, for example, relatively slow trucks 103 are not assigned to the same route as relatively fast trucks 103. It should be clear to a person of ordinary skill in the art that a consequence of assigning relatively slow trucks 103 and relatively fast trucks 103 to the same route may be a reduction in productivity.

In one example, the trucks 103 may be divided into three fleets. The division may be based on a combination of engine and rated horsepower. One fleet may be called “Fast.” Example vehicles for the Fast fleet include the Caterpillar model 797, the Caterpillar model 794, and the Komatsu model 930 Detroit 3000 HP. Another fleet may be called “Slow.” Example vehicles for the Slow fleet include the Komatsu model 980, the HITACHI and the Komatsu model 930 2700 HP. A further fleet may be called “Regular.” An example vehicle for the Regular fleet is the Komatsu model 930E 3000 HP Cummins.

When required, the truck allocation system 100 can generate a set of recommendations. The set of recommendations need not only apply to the trucks 103. Indeed, the set of recommendations may apply to the loading units (the shovels 101 and the loaders 102) and to the dumping sites 105. The vehicle allocation pages 601, including, e.g., a truck-specific vehicle allocation page and a loading-unit-specific vehicle allocation page, may, as illustrated in FIG. 6, include an Available container 611 and a Not Available container 612 and a plurality of vehicle cards 602, on which the statuses of corresponding vehicles are updated automatically. Responsive to a user interaction with (e.g., a click on) a “Reset” user interface element, the truck allocation system 100 may update the vehicle cards 602. As a result of the update, some vehicle cards 602 may change containers. A formerly red vehicle card 602 that has updated to become a green vehicle card 602 or a yellow vehicle card 602 may be observed to move from the Not Available container 612 to the Available container 611. Similarly, formerly green vehicle card 602 or a formerly yellow vehicle card 602 that has updated to become a red vehicle card 602 may be observed to move from the Available container 611 to the Not Available container 612.

As discussed hereinbefore, the entire method whose steps are illustrated FIG. 5 (step 502, step 504, step 506, step 508) may be repeated. The repetition may be triggered automatically, say, at a given time period. Example time periods include a shift, a day and a week. Alternatively, the repetition may be triggered manually.

The user interface presented to the user may include a Recommendation Time Length slider element. The user may use the Recommendation Time Length slider to select the time period between automatic repetitions of the method whose steps are illustrated FIG. 5. The Recommendation Time Length slider may default to time period of, say, 12 hours, with a range of other time periods, e.g., from 6 hours to 24 hours, available for selection, by the user, using the Recommendation Time Length slider.

The user interface presented to the user may include a “New Recommendations” user interface element. Responsive the user interacting with (e.g., clicking on) the New Recommendations user interface element, the user interface may open a dialog. The user may then select, within the dialog, various options that control a manner in which the optimizer algorithm, implemented by the optimizer system 308, operates. One option, available for selection within the dialog, may dictate whether truck transfer between pits should be penalized. The alternative to penalizing truck transfer between pits may be understood to be an allowance for the optimizer algorithm to assume that truck transfer between pits is instantaneous (and unrestricted). Activating the option to allow unrestricted truck transfer between pits may be recognized as helpful when evaluating an ideal state of the mine site. The ideal state of the mine site may be understood to be a state without travel time constraints. Travel time constraints may be understood to have been built into the optimizer algorithm executed at the optimizer system 308.

After input has been received at the truck allocation system 100, e.g., via the data 304 or the dispatcher 111, the truck allocation system 100 may act to generate vehicle allocation recommendations. That is, the truck allocation system 100 may act to allocate vehicles, e.g., the shovels 101, the trucks 103 and the dumping sites 105, in a manner that optimizes productivity (BCM) and finds a low cost solution, based on the received input. From the perspective of a user, e.g., the dispatcher 111, of the user interface, receiving the vehicle allocation recommendations may involve navigating to a Recommendations page. Such navigation may be accomplished by selecting a Recommendations tab in an upper-left corner of a main user interface page.

To manually trigger generation of a new set of recommendations, the dispatcher 111 may provide new inputs to the truck allocation system 100 by interacting with the vehicle pages 602, e.g., vehicle pages 602 for the trucks 103, vehicle pages 602 for the loading units 101, 102, vehicle pages 602 for the dumping sites 105 and vehicle pages 602 for the routes pages. The dispatcher 111 may then interact with (e.g., click on) a Generate New Recommendations user interface element on a Summary user interface page.

Several recommendation sets can be generated with different inputs to evaluate different situations within the mine site. The dispatcher 111 may navigate between the different recommendation sets and each recommendation set can be marked as “Executed” or “Rejected.”

The Recommendations user interface page for a given recommendation set may include the following parts: a timestamp; an Execute user interface element; and a Reject user interface element.

The timestamp may be understood to indicate a time and date at which the given recommendation set was generated. If the given recommendation set was generated in the unrestricted manner, an Unrestricted label may be caused to appear under the timestamp.

The decision, by the dispatcher 111, to accept or reject a given set of recommendations may factor into a performance metric for the truck allocation system 100. Subsequent to a determination of the performance metric, the performance metric may be provided as feedback to the machine learning model 307 and to the optimizer system 308. The performance metric feedback may cause adjustments to be made in the machine learning model 307 and in the optimizer system 308. Such adjustments may be shown to improve future recommendations output by the optimizer system 308.

A Past Recommendations drop-down menu (not shown) can be generated by the truck allocation system 100, e.g., as part of the graphical user interface provided by the truck allocation system 100. The Past Recommendations drop-down menu may be shown to allow the dispatcher 111 to navigate between a current recommendation set and one or more previous recommendation sets. If a given recommendation set was generated in the unrestricted manner, the Unrestricted label appears under the timestamp.

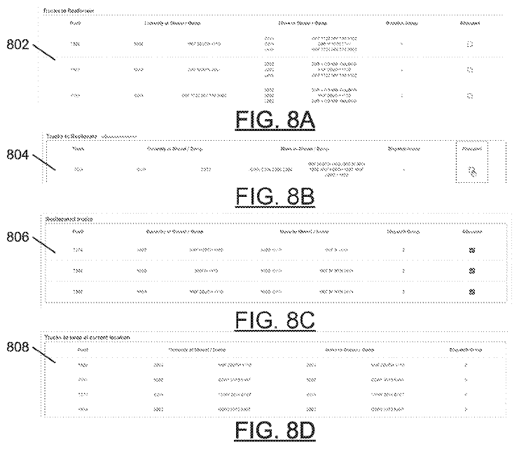

FIG. 8A illustrates a first state 802 of a Trucks to Reallocate table. The Trucks to Reallocate table in the first state 802 displays references to trucks 103 that are to be reassigned to a route to a loader 102 that is distinct from the route to the loader 102 to which the trucks 103 are currently assigned. When reallocating a truck 103 to a given route to a given loader 102, the truck allocation system 1 may automatically assign the reallocated truck 103 to the dumping site 105 that is already associated with the given loader 102. FIG. 8B illustrates a second state 804 of a Trucks to Reallocate table. The Trucks to Reallocate table in the second state 804 displays a single reference to a single truck 103 that is being reassigned to a new route.

FIG. 8C illustrates a Reallocated Trucks table 806. The Reallocated Trucks table 806 of FIG. 8C displays references to the trucks 103 that the truck allocation system 1, via the dispatcher 111, has reallocated according to the model recommendations. If a truck 103 is currently on at least one of the recommended routes (it is recognized that there could, potentially, be more than one route), reallocation is not required, and the trucks may be listed in a Trucks to Keep in Current Location table 808 illustrated in FIG. 8D.

The dispatcher 111 may find, in the Trucks to Reallocate table in the second state 804, trucks 103 that are to be reassigned. The trucks 103 that are to be reassigned may be reassigned automatically. Alternatively, a given truck 103 that is to be reassigned may be manually reassigned responsive to the dispatcher 111 dragging a reference to the given truck 103 to a location associated with a route to a loader 102 that is different from the route to the loader 102 with which the given truck 103 is currently associated. As part of the manual reassignment, the dispatcher 111 may select an “Allocated” check box, thereby marking the given truck 103 as allocated.

A reference to the given truck 103 may be observed to disappear from the Trucks to Reallocate table in the first state 802 (see FIG. 8A) and may be observed to appear in the Reallocated trucks table 806 (see FIG. 8C).

A “non-selected trucks available for non-grouped loaders” table (not shown) may include references to trucks 103 that have been selected as Available but have not been selected, by the truck allocation system 100, to be used for any of the shovels 101 or the loaders 102.

Above the “non-selected trucks available for non-grouped loaders” table, there may be a list of non-grouped loaders 102 that have been reserved to have trucks 103 assigned thereto. The trucks 103 that are listed in the “non-selected trucks available for non-grouped loaders” table may be left in a standby status for the next recommendation or assigned to the non-grouped loaders 102. The dispatcher 111 may decide to assign these trucks 103 to the non-grouped loaders 102.

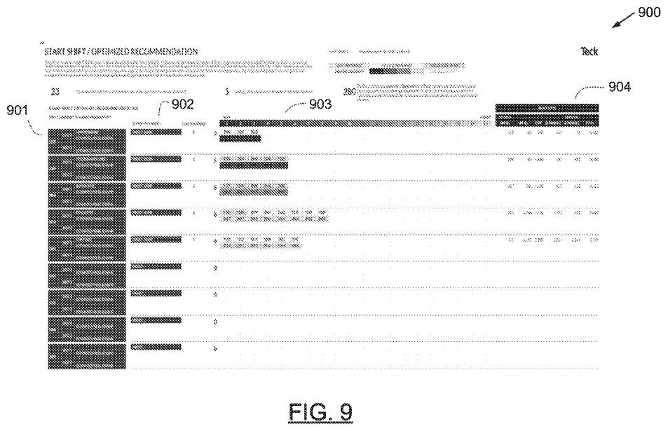

With reference to FIG. 9, the truck allocation system 100 may generate a fully optimized recommendation list 900 of routes with corresponding vehicles, e.g., trucks 103, assigned thereto. The recommendation list 900 may include one or more of the following for a given route: a name 901 of the given route; a target production (BCM) 902; and a list 903 of the trucks 103 that have been assigned to the given route. The trucks 103 in the list 903 may be ranked in order of predicted performance. Each route may include a rating table 904 for each route characteristic, including categories of grade, e.g., extreme uphill, uphill, flat, and extreme downhill, along with a total route score thereof.

To evaluate different situations within the mine site, the dispatcher 111 may control the generation of several recommendation sets on the basis of distinct set of inputs. All generated recommendation sets may, for example, be saved in the memory 303 (see FIG. 3). To navigate from a currently displayed generated recommendation set to a second recommendation set, the dispatcher 111 may select the second recommendation set in the Past Recommendations drop-down menu. Each recommendation set may be marked, in the Past Recommendations drop-down menu, as Executed or Rejected.

When a recommendation set is generated, each recommendation can be accepted, by using the Execute user interface element, or rejected, using the Reject user interface element. By accepting and rejecting the recommendations, a measure of the performance of the truck allocation system 100 can be measured and the truck allocation system 100 can be trained to produce better recommendations in the future. If a given recommendation set is not marked as either Executed or Rejected, it is assumed that the dispatcher 111 was using the given recommendation set for information purposes only and the given recommendation set may not undergo further analysis by the development team.

If a given recommendation set has been deemed satisfactory and has been used to allocate trucks 103 on the mine site, the dispatcher 111 may interact with (e.g., click on) an Executed user interface element.

In a Submit Response dialog box, the dispatcher 111 may provide comments on this recommendation set and then click Submit. The accepted recommendations are marked with Executed label on the recommendation page and on the Past Recommendations drop-down menu.

If the recommendation set has been deemed not to be satisfactory or a mistake was made when providing the input, the dispatcher 111 may interact with (e.g., click on) a Reject user interface element.

In the Submit Response dialog box, the dispatcher 111 may select User Error or Other to indicate the reason for the rejection. In an “Add Comments” field, the dispatcher 111 may specify the user error or provide a reason on why the given recommendation set has been rejected.

When finished editing, the dispatcher 111 may interact with (e.g., click on) a Submit user interface element.

Rejected recommendations may be marked with a Rejected label on the recommendation page and in the Past Recommendations drop-down menu.

In the upper-right corner of a user interface main page provided by the truck allocation system 100, the date and time of when the status of the truck allocation system 100 was refreshed may be illustrated. The truck allocation system 100 may automatically refresh the data every predetermined time period, e.g., five minutes. However, the automatic refresh might not line up. In this case, the dispatcher 111 can also refresh the data manually by selecting Refresh Status. If there is new data, the page will be updated. If the page is already up to date, nothing will happen.

In overview, the truck allocation system 100 may be understood to implement two components in addition to a user interface component, namely, the machine learning model 307 and the optimizer system 308 (see FIG. 3).

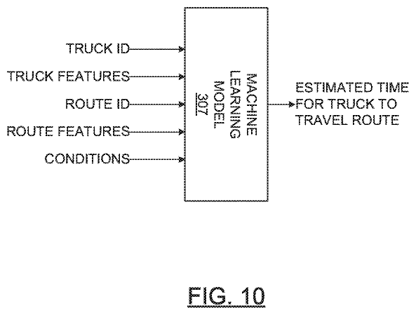

FIG. 10 illustrates, schematically, the machine learning model 307, to emphasize inputs and outputs. As illustrated in FIG. 10, the machine learning model 307 may be understood to receive a plurality of inputs and produce a single output. The inputs include: one or more features of a given truck; one or more features of a given route; and indications of a set of weather conditions. The single output is an estimate of a time that the given truck will take to travel the given route.

As discussed hereinbefore, the features of the given truck may include make, model, horsepower, age and size of truck box. Also as discussed hereinbefore, the features of the given route may include characteristics of a plurality of segments that make up the given route. The characteristics of a segment may include a length of the segment, an indication of a grade and an indication of a curvature. The set of weather conditions may, for example, include an indication of a quantity of precipitation in a predetermined preceding time period (say, 12 hours or 24 hours). The set of weather conditions may, for example, further include an average temperature and an indication of hours of sunlight.

As discussed hereinbefore, the machine learning model 307 may be implemented using the known XGBoost algorithm. Mean square error may be used as an error function when training the machine learning model 307. Known methods of training may be employed to train the machine learning model 307. For example, historical data, for a given truck on a given route, may be used wherein the time that the given truck has taken to travel the given route is known. The machine learning model 307 is provided with input including some features of the given truck, some features of the given route and indications of the set of weather conditions that were present when the given truck traveled the given route. Based on the input, the machine learning model 307 produces output of an estimate of the time for the given truck to travel the given route. The estimate of the time may be compared to the known time taken by the given truck to travel the given route. Based on a difference between the estimate of the time and the known time, a gradient in the XGBoost algorithm implementation of the machine learning model 307 may be adjusted.

Responsive to a repetitive provision of historical data and adjustment of the gradient, it is expected that the accuracy of the machine learning model 307, as measured as a difference between estimated times and corresponding known times, will improve. Such training of the machine learning model 307 may continue to improve until the differences are consistently less than a threshold. Beneficially, once the machine learning model 307 has been trained, it is expected that the machine learning model 307 will output reasonably accurate time estimates for known trucks travelling known routes, even if the known trucks have never travelled the known routes.

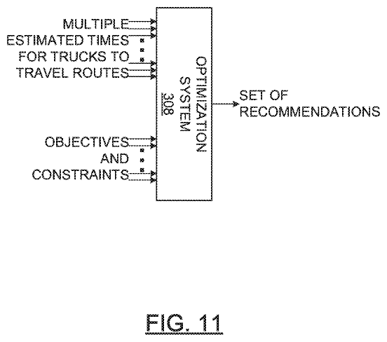

FIG. 11 illustrates, schematically, the optimizer system 308. As discussed hereinbefore, the optimizer system 308 may be implemented using a MILP solver. It is known that useful operation of a MILP solver involves appropriately defining a set of objectives and a set of constraints. Through experimentation, an initial set of defined objectives and constraints may be narrowed down to tighter constraints and fewer objectives.

Indeed, it may be found that some of the input data is noisy and, accordingly, certain constraints may not be significantly tightened. Furthermore, it may be found that certain objectives are not relevant. Some constraints may be universal to the vehicles at the mine site. In contrast, some constraints may be specific to a subset of vehicles. For example, it may be that not every loader 102 can load every truck 103. Accordingly, one constraint may state that a particular truck 103 may not be assigned to a particular route with a particular loader 102 at the terminus of the particular route. Additionally, a constraint has been discussed, hereinbefore, called a Box Factor, related to the number of trucks 103 that may be assigned per route. As part of defining set of objectives and constraints, an impact of fleet mixing may be quantified. The impact may be quantified as a penalty.

An objective may, for example, specify a BCM target for a given shift. Appropriately defining objectives may take into account information that indicates that a given BCM target for a given shift is not always achievable.

Arriving at an appropriately defined set of objectives and constraints may be considered to be an optimization problem. The optimizing of the defined set of objectives and constraints may also take into account complexity. Highly complex optimization may, conveniently, lead to a highly accurate resulting set of recommendations at the output of the optimizer system 308. It should be recognized that there is generally expected to be a correlation between a degree of complexity involved in the optimization and a duration of time taken, by the optimizer system 308, to arrive at a set of recommendations. A highly accurate set of recommendations may be available in conjunction with a run-time of five days. However, the optimizer system 308 may regarded as more useful when set of recommendations may be available in conjunction with a run-time of five minutes. In view of the trade-off between accuracy and run-time, it follows that accuracy may be sacrificed in favor of quick results.

An example constraint may be an indication of specific trucks 103, among the plurality of trucks 103 at the mine site, that are available for allocation.

When carrying out the work of attempting to arrive at an appropriately defined set of objectives and constraints, it may be considered useful to view a particular constraint as variable rather than fixed. A variable constraint may be incrementally increased until the optimizer algorithm implemented by the optimizer system 308 is no longer able to produce a viable set of recommendations.

In aspects of the present application, a so-called “match factor” constraint may be defined. The match factor may be defined in an equation that establishes a relationship between a plurality of trucks 103 and a given shovel 101 or loader 102. For equation purposes, the given shovel 101 or loader 102 may be associated with a letter and each of the plurality of trucks 103 may be associated with a number from 1 to T. The value, T, may be understood to represent the total number of trucks 103 that are assigned to the given shovel 101 or loader 102. It should be clear that, as a consequence of too many trucks 103 being assigned to a route that terminates at the given shovel 101 or loader 102, the trucks 103 will become backed up in a queue (see FIG. 2). It should also be clear that, as a consequence of too few trucks 103 being assigned to the route that terminates at the given shovel 101 or loader 102, the shovel 101 or loader 102 will spend some time idle, waiting for the next ruck 103 to arrive. The match factor constraint equation may include a “shovel cycle” term and a “haul cycle” term. Both terms may be associated with a particular truck 103. The shovel cycle term, s, may be defined to relate to the duration of time expected for the given shovel 101 or loader 102 to load the particular truck 103. The haul cycle term, h, may be defined to relate to the route travel time estimated, by the machine learning model 307, for the particular truck 103 to travel to a designated dumping site 105 and to the route travel time estimated for the particular truck 103 to travel a return route, to the given shovel 101 or loader 102, from the designated dumping site 105. If the given shovel 101 or loader 102 is associated with the letter “a,” then the match factor, wₐ, for the given shovel 101 or loader 102 may be expressed as:

$${w}_{a} = ( \frac{{S}_{a 1}}{{h}_{a 1}} + \frac{{S}_{a 2}}{{h}_{a 2}} + … + \frac{{S}_{aT}}{{h}_{aT}} ) = {\sum }_{r = 1}^{T} \frac{{S}_{ar}}{{h}_{ar}} .$$

When a match factor, w, is provided, to the optimization system, as a constraint, an upper limit may be provided, e.g., w<0.9.

The foregoing description of one or more example embodiments has been presented for the purposes of illustration and description. It is not intended to be exhaustive or to limit the invention to the precise form disclosed. Many modifications and variations are possible in light of the above teaching. It is intended that the scope of the disclosure be limited not by this detailed description.

We claim:

1. A method of determining vehicle travel time for a route at a mine site, the method comprising:
collecting, from a plurality of vehicles, recorded historical vehicle operation data, the historical vehicle operation data specifying a route, among a plurality of routes at the mine site, on which the historical vehicle operation data has been recorded;
training, using the historical vehicle operation data, a machine learning system to estimate a travel time for a particular vehicle on a particular route, thereby generating a trained machine learning system, the historical vehicle operation data including:
vehicle features for the particular vehicle;
route features for the particular route; and
weather condition data; and
determining, using the trained machine learning system, an estimated travel time for a vehicle among the plurality of vehicles on a route among the plurality of routes at the mine site.

2. The method of claim 1, wherein the historical vehicle operation data comprises vehicle operation data recorded over a predetermined time period.

3. The method of claim 1, further comprising, before the training, filtering the recorded historical vehicle operation data to remove recorded historical vehicle operation data representative of an average vehicles speed less than 10 km/h.

4. The method of claim 1, further comprising, before the training, filtering the recorded historical vehicle operation data to remove recorded historical vehicle operation data representative of an average vehicles speed greater than 60 km/h.

5. The method of claim 1, further comprising, before the training, filtering the recorded historical vehicle operation data to remove recorded historical vehicle operation data on routes with data recorded over fewer than a minimum number of cycles.

6. The method of claim 5, wherein the minimum number of cycles comprises 10 cycles.

7. The method of claim 1, wherein the route features comprise grade data for a segment of the particular route.

8. The method of claim 1, wherein the route features comprise curvature data for a segment of the particular route.

9. The method of claim 1, wherein the vehicle features comprise an indication of a model for the particular vehicle.

10. The method of claim 1, wherein the vehicle features comprise an indication of a horsepower rating for the particular vehicle.

11. The method of claim 1, wherein the recorded historical vehicle operation data further comprises a time taken for a particular loader to load the particular vehicle.

12. The method of claim 1, wherein the recorded historical vehicle operation data further comprises a rate at which a particular shovel digs material.

13. A system for determining vehicle travel time for a route at a mine site, the system comprising:
a non-transitory memory storing computer instructions; and
a controller processor, the controller processor caused, by executing the instructions, to:
collect, from a plurality of vehicles, recorded historical vehicle operation data, the historical vehicle operation data specifying a route, among a plurality of routes at the mine site, on which the historical vehicle operation data has been recorded;
train, using the historical vehicle operation data, a machine learning system to estimate a travel time for a particular vehicle on a particular route, thereby generating a trained machine learning system, the historical vehicle operation data including:
vehicle features for the particular vehicle;
route features for the particular route; and
weather condition data; and
determine, using the trained machine learning system, an estimated travel time for a vehicle among the plurality of vehicles on a route among the plurality of routes at the mine site.

14. A method of producing vehicle allocation recommendations, the method comprising:
obtaining a plurality of estimated cycle times for a plurality of vehicles on a plurality of routes at a mine site, each cycle time obtained by summing a first estimated travel time for a particular vehicle, among the plurality of vehicles at a mine site, traveling on a first route, among the plurality of routes, in a first direction and a second estimated travel time for the particular vehicle traveling on a second route, among the plurality of routes, in a second direction;
obtaining a plurality of constraints, the plurality of constraints including a penalty for fleet mixing;
obtaining a plurality of objectives, the plurality of objectives including a shovel target;
providing, to an optimizer system executing an optimizer algorithm:
the plurality of estimated cycle times;
the plurality of constraints; and
the plurality of objectives;
receiving, from the optimizer system subsequent to execution of the optimizer algorithm, an optimizer output including a plurality of vehicle allocation recommendations.

15. The method of claim 14, wherein the plurality of constraints comprises an indication of specific vehicles, among the plurality of vehicles, that are available for allocation.

16. The method of claim 14, wherein the plurality of constraints comprises an equation describing a relationship between a truck and a loader.

17. The method of claim 14, wherein the plurality of objectives comprises minimizing overall cost.

18. The method of claim 14, wherein the plurality of objectives comprises minimizing a fuel burn rate.

19. The method of claim 14, wherein the plurality of objectives comprises increasing total material moved.

20. The method of claim 14, wherein the shovel target comprises an amount of material.

21. The method of claim 14, wherein the shovel target comprises a time period.

22. The method of claim 21, wherein the time period comprises a shift.

23. A system for determining vehicle travel time for a route at a mine site, the system comprising:
a non-transitory memory storing computer instructions; and
a controller processor, the controller processor caused, by executing the instructions, to:
obtain a plurality of estimated cycle times for a plurality of vehicles on a plurality of routes at a mine site, each cycle time obtained by summing a first estimated travel time for a particular vehicle, among the plurality of vehicles, traveling on a first route, among the plurality of routes at a mine site, in a first direction and a second estimated travel time for the particular vehicle traveling on a second route, among the plurality of routes, in a second direction;
obtain a plurality of constraints, the plurality of constraints including a penalty for fleet mixing;
obtain a plurality of objectives, the plurality of objectives including a shovel target;
provide, to an optimizer system executing an optimizer algorithm:
the plurality of estimated cycle times;
the plurality of constraints; and
the plurality of objectives; and
receive, from the optimizer system subsequent to execution of the optimizer algorithm, an optimizer output including a plurality of vehicle allocation recommendations.
